(19) United States
(12) Patent Application Publication
(10) Pub. No.: US 2003/0163429 A1
(43) Pub. Date: Aug. 28, 2003

(54) Data conversion secure transfer method and software system for court reporters and scopists

(76) Inventors: Paul Joseph Humbeutel, Denver, CO (US); Ron van Os, Morrison, CO (US)

Correspondence Address: Jacques M. Dulin, Esq., Innovation Law Group, Ltd., Suite 24, 271 South 7th Avenue, Sequim, WA, 98382-3652, US

(21) Appl. No.: 10/374,454

(22) Filed: Feb. 25, 2003

Related U.S. Application Data
(60) Provisional application No. 60/360,612, filed on Feb. 27, 2002.

(51) Int. Cl. G06F 17/60

(52) U.S. Cl. 705/51

(57) ABSTRACT

A single application program and system process whereby digital media or sound files, typically those derived from a court hearing, are converted, compressed, encrypted, and sent electronically to an FTP site by a court reporter. The converted files are then retrieved electronically via FTP from said site by a scopist whereby the files are decompressed, decrypted, and displayed on the scopist's computer. Such functions are conducted in a secure manner so as to produce secure data file format which allows users to effectively transfer the files across the Internet. The inventive application program provides executable code providing computer instructions and operation functionality of providing for files to be stored on an FTP Internet site, and includes means for verification of user's serial numbers for authentication of valid users, and prevention of unauthorized access to the secure data. Converted and completed files from the scopist are either uploaded to a final destination via electronic email or replacing them on an FTP Internet site as designated by the inventive method.

### CROSS-REFERENCE TO RELATED APPLICATIONS

This is a the Regular patent application of prior Provisional Application Serial No. 60/360,612 filed Feb. 27, 2002, the benefit of which is claimed under 35 U.S.C. §119.

### FIELD

The invention relates to a method for data conversion and secure transfer, and more particularly to computer software system architecture and application program providing method functionality whereby digital audio media files, typically those derived from (generated in) court hearings, meetings and depositions, are compressed into easily and securely transferred file formats. The inventive method includes compressing, decompressing, encrypting and converting said files into a secure data file format which allows users to effectively transfer the files across the Internet and to convert the audio record into page text format of typical court transcripts. The inventive system includes a license verification system to confirm a user's authorization to use said software application process, and prevent unauthorized access to the secure data.

### BACKGROUND OF THE INVENTION

The invention most closely corresponds with USPTO Class 341, Coded Data Generation or Conversion in that this invention provides for compression and decompression, encryption and decryption, and electronic transfer of large digital content into an end product in editable format.

Currently, the process of transferring sound recordings of court hearings and depositions between remote computers is labor intensive and difficult due to the size of computer files and the rate of data transfer. Indeed, some of the files are so large, and the quality of lines sufficiently poor that the chance of transfer of a complete file is highly problematic. Further, the rate of transfer in the present day takes approximately twenty-two hours for a 200 megabyte file to be sent across traditional modes such as the Internet or an email program. There is no method available to court reporters that efficiently performs all tasks required: the collection, conversion and transfer of audio recording data into a format which can be edited, printed, and finally submitted to a court, the parties, or attorneys for the parties in the traditional “transcript” format.

The size of files and a lack of means for compressing and securely transferring such files from a court hearing sound recording into usable file data by scopists has resulted in prior methods which are not a single source application, but rather comprise a several step process involving multiple programs of problematic compatibility (they do not interface easily or with complete congruity), and in which the methods are not secure. The security issue is one that poses extreme risk to a person transferring a highly confidential legal transcript, and the prior art would only allow for a straight electronic transfer such as email or sending directly across the Internet. The prior art method provides absolutely no security, and any “hacker” of reasonable skill is able to “capture” the data and use it in any way they wish.

U.S. Pat. No. 4,924,387, which is the closest example of relevant prior art, discloses a court reporting system for simultaneous written and video records of a court hearing, but that system fails to provide a method for transferring such a file to an end-user, being a scopist or transcriber, let alone a secure method.

Accordingly, there is a significant and long-felt need in the art for software-driven computer manipulation of a sound recording such that the file is automatically converted electronically from a sound recording into a data file, sent electronically, quickly and securely from one user to another, and results in a form permitting an end-user to modify said converted data files.

### THE INVENTION

Summary, Objects and Advantages

The invention comprises in its broadest aspects, a software system resolution of current limitations relating to compression/decompression, encryption/decryption, conversion from audio to data, and finally, fast secure transfer of the files within a single, easy to use application program.

Further, the invention provides for a unique serial number-based license management system whereby a designated server receives and verifies licensed user data to allow for efficient verification and control of qualified users, and selective access by a license group to the secure data. A qualified user is defined as a user who has provided compensation or payment for membership in the software application license-group, or who is an authorized employee or other recognized agent of a qualified user. The license group is defined as a group of users who are approved for secure access to, and transfer of, the encrypted content provided by the software application. Such a group includes court reporters, scopists, and agents of either who may be conducting work for hire for the reporter or scopist. The licensing portion functionality of the invention prevents unauthorized access to the file contents, or copying of the actual software application itself by applying any usable industry standard copy protection to the software code.

The system application program enables secure asynchronous file transfer between distinct, separate locations or users. Such transfer is enabled by the program once the inventive software has been installed onto a user's computer, as detailed hereafter. A user or location is defined as a court reporter inputting data, a scopist retrieving and modifying the data provided by the court reporter from a personal computer, or a scopist assistant retrieving and modifying the data provided by the court reporter from a personal computer. A scopist is a person who transcribes sound recording files into a computer file format which is then utilized by a court reporter or attorney to create hard copy court hearing, meeting or deposition data in transcript or other requested format.

Data is initially sent to the application or software system as an audio file, which is a sound recording of a court hearing. The inventive system/program then identifies the file types, i.e. audio or digital content, and accurately converts only the audio file portion into a data format by applying a conversion such as single channel MP3. This conversion can be performed by software programs such as Eclipse or CAT. Once converted, the file or files are compressed into a manageable size file optimized for audio, which is an important aspect of the application method and encrypted to allow for the court reporter's ease of editing, printing, and submitting the data to the court and/or attorney.

The compressed files are encrypted for security and sent via FTP to a document storage server where they await retrieval by an authorized scopist or scopist assistant. Simultaneous to the FTP process, the identity of the original user is sent via HTTP to a separate license management server for verification of the serial number of the user (provided upon installation of the software), as well as a hardware ID that is assigned upon installation and registration of the software. The inventive software system, including the application program, provides control pursuant to an associated license agreement whereby the user inputs selected information, including a serial number provided by the software vendor, their name and/or company name, e-mail address, file extension presets, and in some cases a user managed FTP site address. This input of data is required only on the first instance of use, and thereafter will be automatically identified by the inventive software system via a recognition system created by the software vendor. This verification process can be performed by industry standard programs, but is preferably specific code written for the inventive method.

Upon completion of the file compression, encryption, authorization by the separate license server, and storage on the FTP site, the scopist may now view files to be modified by his or her scoping business by downloading the data from the FTP site. This stage in the method is considered an “order” from a court reporter to a scopist for transcription work on the files. The transfer details are automatically made available to all the parties within the license group as defined supra, thereby being capable of checking status of “orders” placed, and whether they have been picked up (retrieved) by either the court reporter or the scopist.

The application program decrypts the data, decompresses the archive, and makes the enclosed files available to the scopist to “proof”. The finished product, which is a fully converted court reporter's transcript from the audio file to a formatted data file, is then returned to the client or other authorized user via an e-mail attachment. The client or user is then able to manipulate the data as needed, an example being to utilize the data in a word processing application.

### BRIEF DESCRIPTION OF THE DRAWINGS

The invention is described in further detail by reference to the drawings in which:

FIG. 1 is a flow chart depicting the inventive system and process steps in relation to data as it travels from a user's computer through conversion, compression, encryption, a license management process, document storage and retrieval, and finally, to a download client, or end-user's computer where further data conversion occurs.

FIG. 2 is a sample screenshot of what a court reporter, as a user, sees on his or her computer screen, the example shown being the compression of an audio file into a data file, illustrated herein as a text file; and

FIG. 3 is a sample screenshot of what scopists, as users of the inventive system method, view on their computer screens while implementing or utilizing said invention, the example shown being the decompression and decryption of files as converted by the inventive process.

### DETAILED DESCRIPTION, INCLUDING THE CURRENT BEST MODE OF CARRYING OUT THE INVENTION

The following detailed description illustrates the invention by way of example, not by way of 1 imitation of the principles of the invention. This description will clearly enable one skilled in the art to make and use the invention, and describes various embodiments, adaptations, variations, alternatives, and uses of the invention. The description includes what are presently believed to be the best modes of carrying out the invention.

In this regard, the invention is illustrated in three figures that are sufficiently complex as to illuminate to one skilled in the art of software architecture, programming, and computer operations, viable method for making and using the invention.

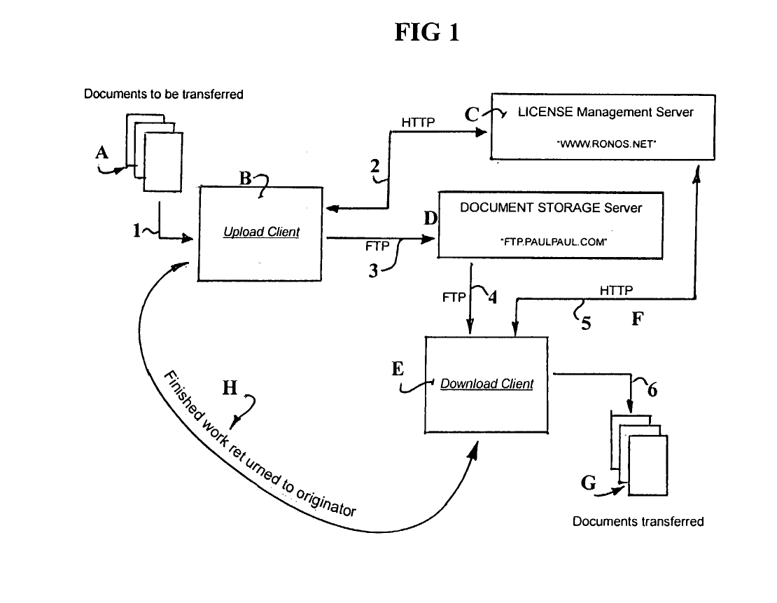

FIG. 1 shows the overall inventive system architecture comprising a computer system in which the inventive application program elements are loaded in B and E. An end-user's “documents” or files to be transferred, A, are in the form of original, fully-expanded sound recording or audio files. B is an upload client which typically consists of a court reporter's computer containing the inventive application program installed. At this step, the files A are accepted 1 by the upload client's system B by the user inputting the audio files into their system B, via a program selected by the court reporter, i.e. the typical software the reporter utilizes for their court hearing transcriptions, such as Eclipse or CAT. The inventive application program in B is initiated by the user to apply an audio file data compression to reduce the bit size of the file into a manageable size, i.e. one that can be transmitted rapidly. Any commercially available compression program optimized for audio files may be utilized during this step.

The inventive application program initially installed on upload client B also applies encryption to the file(s) to convert them into securely coded data recognizable only by authorized users in the subsequent steps in the process as enabled by the inventive software application.

The user's identity is transmitted via HTTP, 2 by the upload client B to license management server C, wherein the user's serial number and hardware ID is verified and approved or rejected based upon the authenticity of the information. At this step, copy protection may be applied to the files utilizing industry standard copy protection methods to prevent unauthorized copy of the software or files themselves. Upon verification and ping-back release by the license management server C to the upload client B, the files are transferred, 3 by the program to the storage server D.

A document storage server D is implemented by way of an FTP (file transfer protocol) Internet site wherein files are stored and retrieved. A download client E, an end-user scopist's computer system, selects which files to retrieve by checking the FTP site for “orders”. Upon selection of the files, the scopist's identity information is sent via HTTP 5 to license management server C, wherein the same checks are performed as detailed supra.

The scopist E, is now able to select files to be proofed from the FTP site (orders), and can perform the typical function of scopists, which is to insure the data in a court transcript matches both in text and voice recording. Once complete, scopist E saves the completed files 6 into any digital content form he or she selects, or that the court reporter B has requested. Finally, the files can be emailed or transferred otherwise electronically H to the court reporter B, in a fast, secure manner.

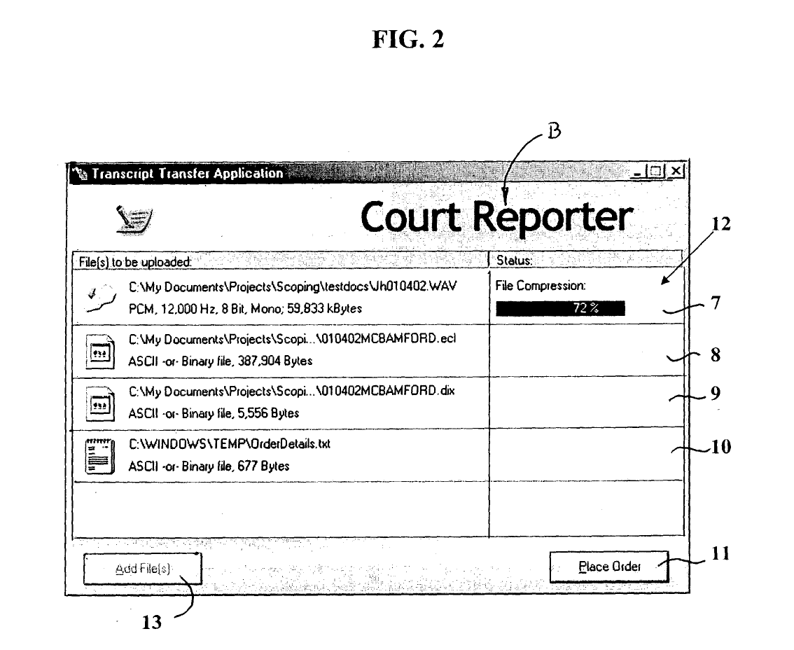

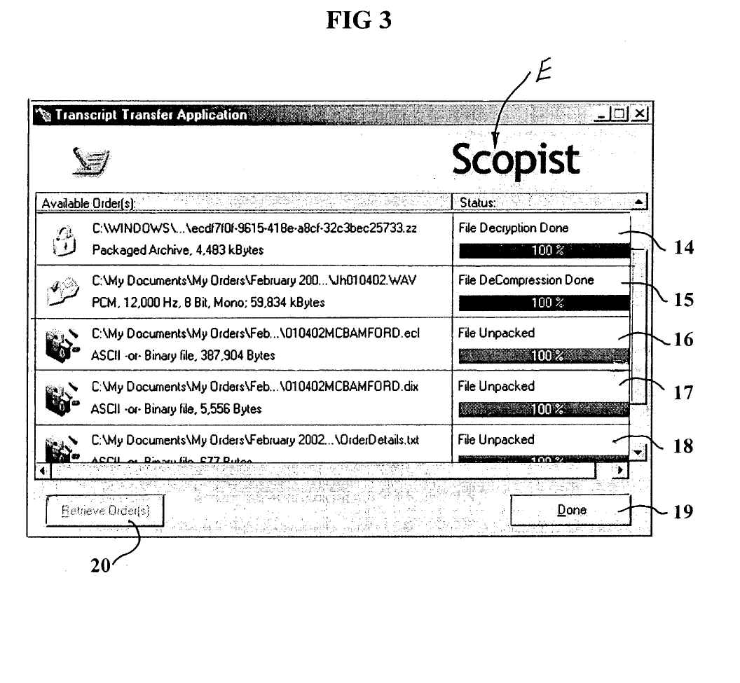

FIG. 2 illustrates an exemplary computer screenshot of what a court reporter user, B views on his or her computer as residing on the document storage sever D. The files (orders) to be uploaded as in FIG. 1 are shown in list form to the left of the screen 7-10. In this exemplar, the first file 7 is an audio file, 8 is a dictionary file (created by the court reporter's transcription software, not included in the invention claimed herein), and 9 and 10 are stenography files as created by the court reporter. The status of the corresponding file compression is shown under the “Status” column 12 on the right side of the screen. The program selected functionality is activated by a “button”11 for placing an order via the software application as shown on the bottom right of the screen. The functionality of the inventive application program then sends selected files to the storage server D, after applying the above described compression and encryption, whereby the download client E can view the files (orders) by selecting the “retrieve orders” button 20 shown in FIG. 3. The user can also select button 13 of FIG. 2 to add new files to be uploaded onto their system if they have several files to upload.

FIG. 3 illustrates an exemplary computer screenshot of what a scopist, E views as residing on the FTP document storage server as orders placed by the court reporter B. 14 illustrates a file being decrypted as occurs on user E's computer via the inventive application method. 14-18 illustrate the decompression steps and the unpacking of the aforementioned files created by the court reporter B's software not associated with the herein claimed invention. The process may then be repeated by the user E selecting the “retrieve orders” button 20 on the bottom left of the screen, or the “done” button 19 upon completion of files as selected as orders.

1) A software application program method for compression, conversion, and secure electronic transfer of a sound recording file into a data file, having executable code for performing the steps of:
a) receiving digital audio files from an originator into a computer system comprising an upload client computer;
b) identifying and verifying said user's license privileges via a license management server;
c) compressing said files into manageable data bits;
d) encrypting said files into a secure data code;
e) translating and converting said files into data format for transfer to a receiving user, and finally back to said originator.

2) A program as in claim 1, wherein said application program in said upload client provides asynchronous file transfer capabilities for receiving said digital audio files, and wherein said code provides for:
a) optimizing the compression of audio files;
b) encryption of said compressed converted data file into secure software code;

3) A program as in claim 2 wherein said independent license management server is an independent server connected to said upload client computer via the Internet for receiving selected data, identifying said upload client computer user ins aid identifying steps to confirm that said user is authorized to use said program.

4) A program as in claim 3 wherein said Internet connected server reads HTTP data input from said upload client computer user and includes executable code providing data processing comprising the steps of:
a) tracking and verifying user serial number based upon an active serial number;
b) accepting an order for file transfer placed by an end-user wishing to sends aid files to a document storage server;
c) applying copy protection to files.

5) A method for storing uploaded data on a document storage server (computer) comprising:
a) a storage system running an FTP service for secure file storage and retrieval;
b) a method for reading encrypted data.

6) A method for management of said files as downloaded onto a client or user's computer from said document storage server, comprising:
a) a method for decompressing said files;
b) a method for decrypting said encrypted files.
